(19) United States
(12) Patent Application Publication
(10) Pub. No.: US 2005/0195401 A1
(43) Pub. Date: Sep. 8, 2005

(54) Wavelength meter

(76) Inventors: Hong-Xi Cao, Hsinchu (TW); Ricky Hsu, Hsinchu (TW)

Correspondence Address: HARNESS, DICKEY & PIERCE, P.L.C., P.O. BOX 8910, RESTON, VA, 20195, US

(21) Appl. No.: 10/922,896

(22) Filed: Aug. 23, 2004

(30) Foreign Application Priority Data
Mar. 2, 2004 (TW) 93105438

(51) Int. Cl. G01B 9/02

(52) U.S. Cl. 356/454

(57) ABSTRACT

A wavelength meter is combined with optical elements to measure the wavelength in order to change communication channels by adjusting the wavelength. The wavelength meter has two wavelength-dependent interferometers with a lower sensitivity on large wavelength ranges and a higher sensitivity on small wavelength ranges, respectively. Each interferometer provides an output signal having an intensity that varies with wavelength. Using the interferometer with a lower sensitivity on large wavelength ranges to first determine a rough range of the wavelength of an incident optical signal, it then uses the interferometer with a higher sensitivity on small wavelength ranges to measure the accurate wavelength of the incident optical beam.

### BACKGROUND OF THE INVENTION

1. Field of Invention

The invention relates to a wavelength meter used in optical signal transceiving systems of tunable laser sources, tunable opto-electrical converters, normal wavelength measurements, and tunable wavelength lockers. In particular, the invention relates to a small-size wavelength meter that can be combined with optical elements.

2. Related Art

In the coming E-world, network applications such as online shopping and online games have increasing demands for the bandwidth. Fiber to The Home (FTTH), Chaos Wavelength Division Multiplexing (CWDM), Dense Wavelength Division Multiplexing (DWDM) will become the mainstream of future broadband communications. In the WDM applications, it is an important thing to be able to measure the optical wavelength at any time to determine or change communication channels. Existing wavelength meters are either huge and incompatible with optical transceivers or limited to a single communication channel. Therefore, their commercial and in-home applications are very restricted.

The most commonly seen means of measuring the wavelength are the diffractive grating method and the Michelson interference method. The diffractive grating method is shown in FIG. 1A. A grating 11 splits a beam of light into different direction according to the wavelength. Photo sensors are at different positions then receive the optical signals. Alternatively, one can use a stepping motor to rotate the grating, thereby selecting the wavelength. This method covers a wider wavelength range and has a fast scanning speed. Therefore, it is widely used by people. The Michelson interference method, shown in FIG. 1B, employs the Michelson interferometer in its basic structure. The working principles are as follows. A beam splitter 12 splits a beam of light into two beams. A stepping motor (not shown in the drawing) drives the reflectors 13, 14 to adjust the optical path lengths of the two beams, generating an interference stripe pattern 16 on a screen 15 to measure the wavelength. This method uses a stable built-in light source (usually a gas laser) to adjust the measurement errors. Therefore, it often gives more precise wavelength measurements. However, both of the above-mentioned two methods require high-precision motor controls and appropriate optical paths. The volume of the whole system is hard to minimize. Therefore, it is difficult to integrate the system with existing optical communication elements. The U.S. Pat. No. 5,798,859 of JDSU in 1998 uses the Fabry-Perot interference in the wavelength locker. That is, the light is fixed at a predetermined wavelength. The wavelength is locked using the Fabry-Perot interference so that the optical wavelength is maintained at the desired wavelength even when the element experiences bad conditions or temperature drifts. With reference to FIGS. 2A and 2B, reflecting light is partially reflected by a partial reflector 21 to a first photo detector 22; the other part penetrates through the partial reflector 21 and passes the filtering of the interferometer 23, received by a second photo detector 24. The interferometer 23 is wavelength-dependent; it outputs optical signals of difference powers according to the wavelengths of different optical signals. Its characteristic curve is given in FIG. 2B. In the drawing, the lights L1, L2, L3 have the same power. Therefore, the second photo detector 24 determines that they are the same. In other words, their wavelengths cannot be correctly determined. Therefore, it cannot be used as a wavelength meter.

### SUMMARY OF THE INVENTION

In view of the foregoing, the invention provides a wavelength meter that provides a small-size wavelength meter that can be integrated with existing optical communication elements. It enables the original communication device to know the wavelength used in current communications, thereby changing its wavelength to switch communication channels. This enhances the flexibility of the original communication device.

The disclosed wavelength meter contains a beam splitting device, two interferometers, and two photo sensors. The beam splitting device separates an incident beam into two beams of light, transmitting to the interferometers. The interferometers are wavelength-dependent, having different optical power outputs for optical signals of different wavelengths. The characteristic curves of the two interferometers have a low sensitivity on large wavelength ranges and a higher sensitivity on small wavelength ranges, respectively. The rough range of the wavelength of the optical signal can be determined by comparing the optical power of the interferometer with a low sensitivity on large wavelength ranges and its corresponding characteristic curve. The wavelength is then determined by comparing the optical power of the interferometer with a higher sensitivity on small wavelength ranges and its corresponding characteristic curve. Therefore, the wavelength of the incident light can be accurately measured or locked. The invention has the features of a small size, a large measurement range, and a high precision.

### BRIEF DESCRIPTION OF THE DRAWINGS

The invention will become more fully understood from the detailed description given hereinbelow illustration only, and thus are not limitative of the present invention, and wherein:

FIGS. 1A and 1B are schematic views of a conventional wavelength meter;

FIGS. 2A and 2B are schematic views of a conventional wavelength locker;

FIG. 3 is a schematic view of the invention;

FIGS. 4A to 4D are schematic views of the characteristic curves of the interferometers used in the invention;

FIG. 5 is a schematic view of the invention used in optical communications;

FIGS. 6A to 6H are variations of FIG. 5; and

FIGS. 7A and 7B show applications of the invention.

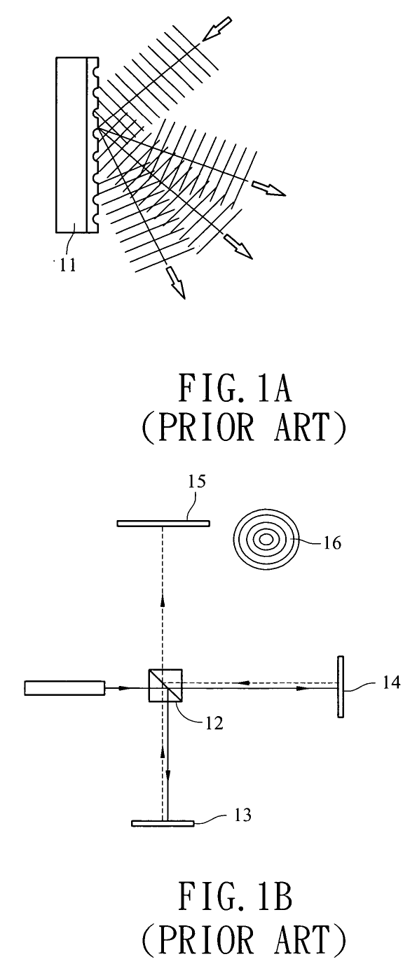

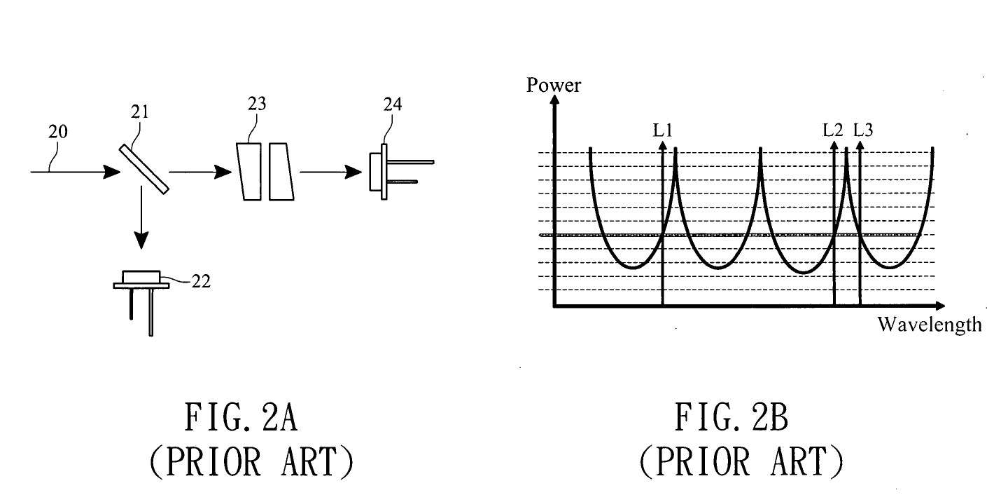

### DETAILED DESCRIPTION OF THE INVENTION

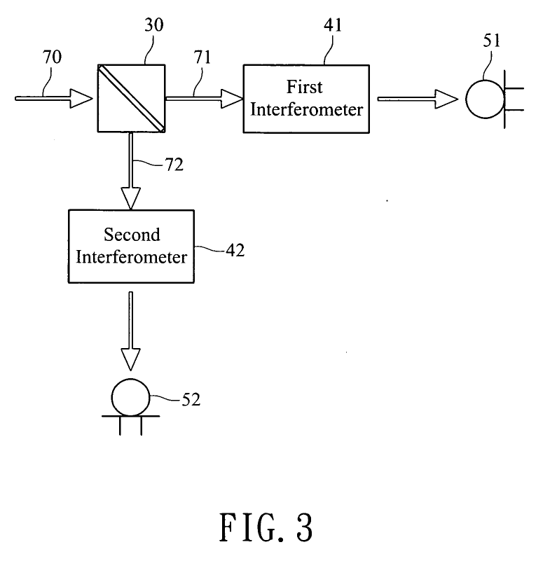

As shown in FIG. 3, the disclosed wavelength meter contains a beam splitting device 30, a first interferometer 41, a second interferometer 42, and, correspondingly, a first photo sensor 51 and a second photo sensor 52. An incident beam 70 is projected on the beam-splitting device 30 and split into two beams 71, 72, entering the first interferometer 41 and the second interferometer 42, respectively. The first interferometer 41 and the second interferometer 42 are wavelength-dependent. That is, they have different optical power outputs for different input beams 71, 72. The optical power outputs are transmitted to the first photo sensor 51 and the second photo sensor 52. The wavelength of the incident beam 70 is determined by comparing the measured powers of the beams 71, 72 and the characteristic curves of the first interferometer 51 and the second interferometer 52.

In view of the drawbacks in the conventional wavelength locker, the invention uses two interferometers to accurately determine the wavelength. The first interferometer 41 has a low sensitivity on large wavelength ranges, and the second interferometer 42 has a high sensitivity on small wavelength ranges. Using the beam 71 passing through the first interferometer 41, the first photo sensor 51 measures its power and compares it with the characteristic curve of the first interferometer 41 to find out a rough wavelength range of the incident beam 70. Using the beam 72 passing through the second interferometer 42, the second photo sensor 52 measures its power and compares it with the characteristic curve of the second interferometer 42 to find out a more accurate wavelength.

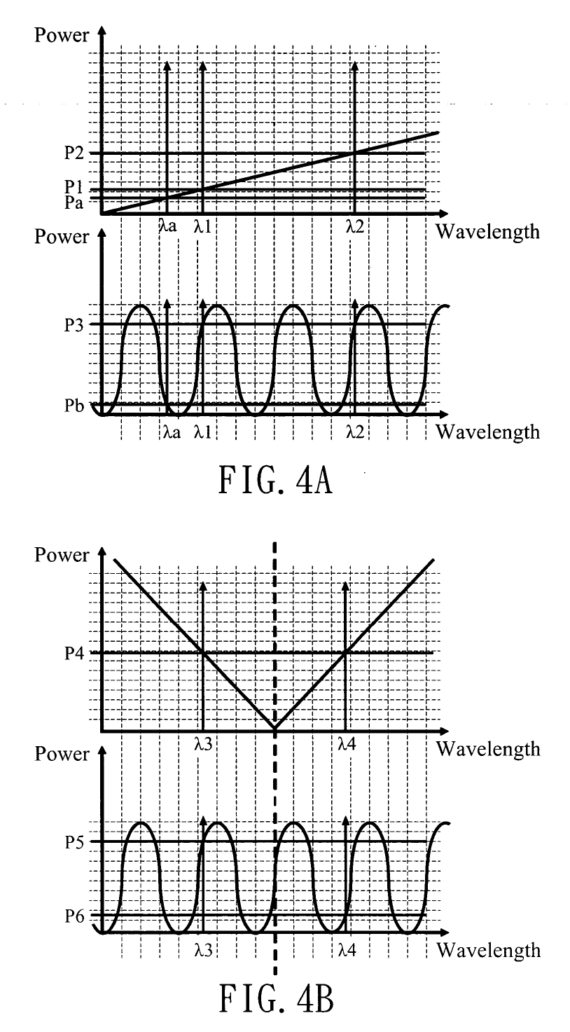

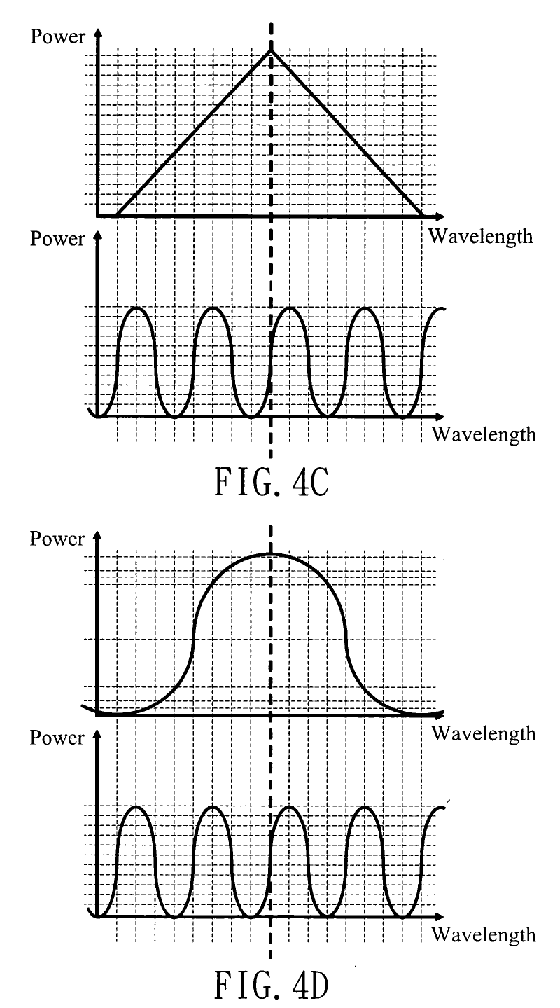

Therefore, the characteristic curves of the first interferometer 41 and the second interferometer 42 have to be properly matched in such way to be able to accurately determine the wavelength. As shown in FIG. 4A, the characteristic curve of the first interferometer 41 is roughly a slant line (the upper part) while that of the second interferometer 42 is a periodic wave (the lower part). For example, beams of light with wavelengths λ1 and λ2 pass through the second interferometer 42 and are measured by the second photo sensor 52 to have power P3, but they are measured by the first photo sensor 51 to have different powers P1 and P2. Thus, the two interferometers can give accurate information about the wavelength. Generally speaking, the interferometer with a slant characteristic curve can be a Fabry-Perot interferometer, an etalon or thin-film filter, or a fiber Bragg grating (FBG). The wide the wavelength range it covers, the lower its sensitivity is. (That is, the power changes slightly only when the wavelength varies a lot.) Even though the wavelengths λ1 and λa correspond to the powers P1 and Pa, their difference is very small, even smaller than the error caused by the smallest discriminating power or noise of the photo sensor. Therefore, it is impossible to use only one interferometer to determine accurately the wavelength. The interferometer with a periodic characteristic curve can be a Fabry-Perot interferometer, an etalon or thin-film filter, or a fiber Bragg grating (FBG). Even though it has a higher sensitivity on small wavelength ranges (i.e. the output power changes even when the wavelength is only slightly changed), the cycle repeats itself. Therefore, one has to combine a first interferometer 41 with a low sensitivity on large wavelength ranges and a second interferometer 42 with a high sensitivity on small wavelength ranges. For example, the first interferometer 41 covers wider wavelength ranges (such as 1450˜1650 nm, 1250 nm˜1450 nm, 800 nm˜1250 nm, 380 nm˜800 nm, etc) to determine the rough position of the incident wavelength 70. The free spectral range (FSR) of the second interferometer 42 is smaller (such as 1.6 nm, 0.8 nm, 0.4 nm, 0.2 nm, 0.1 nm, etc). Therefore, it can be used to accurately measure or lock the wavelength of the incident light.

Of course, the characteristic curve of the first interferometer 41 can have a V or U shape (FIG. 4B), whose central symmetric line overlaps with the origin of the periodic wave of the second interferometer 42. For example, wavelengths λ3 and λ4 have the same power P4 for the first interferometer 41. From the second interferometer 42, they have the powers P5 and P6, respectively. (One is positive and the other is negative as seen from the waveform.) Without departing from the spirit of the invention, one may also flip the characteristic curve (FIG. 4C).

On the other hand, the characteristic curve of the first interferometer 41 can be designed to have a periodic wave shape (FIG. 4D). However, in order to achieve the requirement of covering large wavelength ranges, it has to satisfy FSR1=2*n*FSR2+Δ or FSR1=2*(n+½)*FSR2+Δ, where FSR1 is the FSR of the first interferometer 41, FSR2 is the FSR of the second interferometer 42, and n is an arbitrary integer. Δ is a fine-tuning constant so that the spectra of the first interferometer 41 and the second interferometer 42 have a difference when the penetrating powers are the same. This avoids the spectrum hole penetration phenomena. In practice, the correction is determined according to the measured finesses of the interferometers. This is because interferometers must have intrinsic errors. Therefore, they need a fine-tuning constant to provide correct characteristic curves.

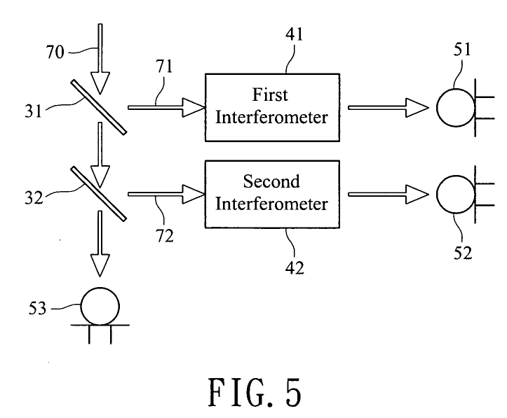

After the optical signal 70 passes through the disclosed optical wavelength meter, sometimes it has to propagate outward in order to couple with other optical systems. Therefore, the incident light 70 is split twice. With reference to FIG. 5, the beam splitting devices 31, 32 split the incident beam 70 using part of the beam splitters into the first interferometer 41 and the second interferometer 42. The rest of the light still enters the photo sensor 53 (which can be replaced by another device according to needs).

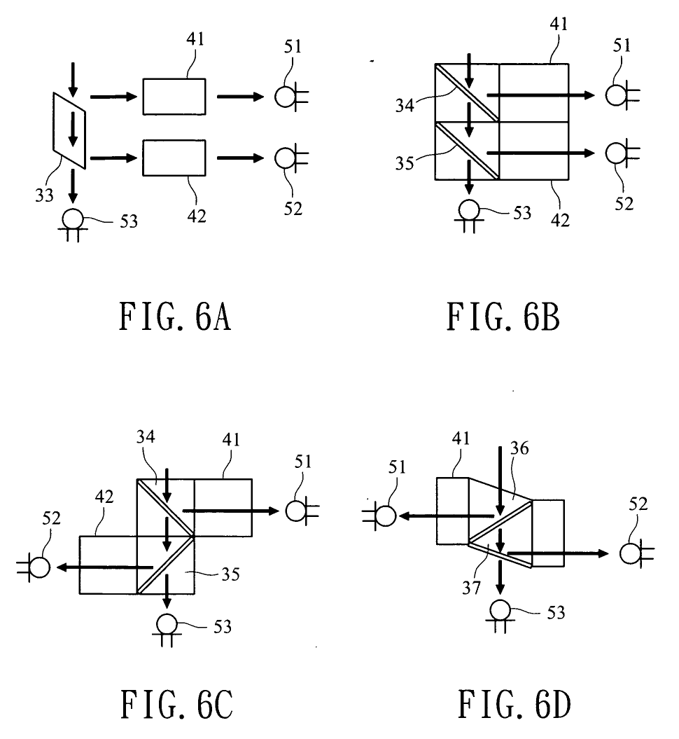

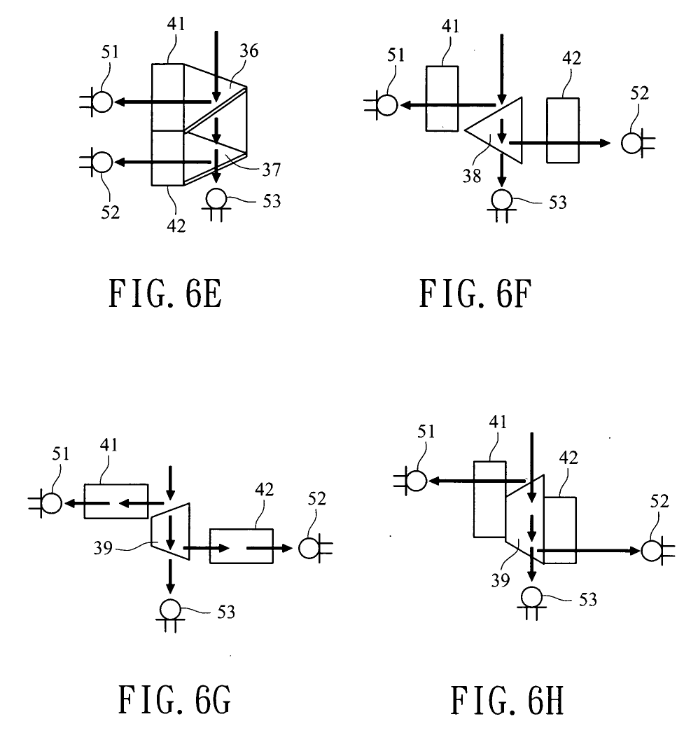

The implementation of the beam splitting device 30 also has many different variations in practice. For example, the two beam splitters in FIG. 5 can be integrated into a quadrangular crystal beam splitting device 33 (FIG. 6A) or two sets of rectangular beam splitting devices 34, 35 (FIGS. 6B and 6C). In FIGS. 6D and 6E, two sets of triangular pillars are used to constitute a double beam splitter as the beam splitting devices 36, 37. One may also combine the whole module into a device to minimize the system space. In FIG. 6F, the two sets of beam splitters are replaced by a triangular pillar crystal as the beam splitter 38. Of course, one can use a trapezoid crystal as the beam splitting device 39 (see FIGS. 6G and 6H).

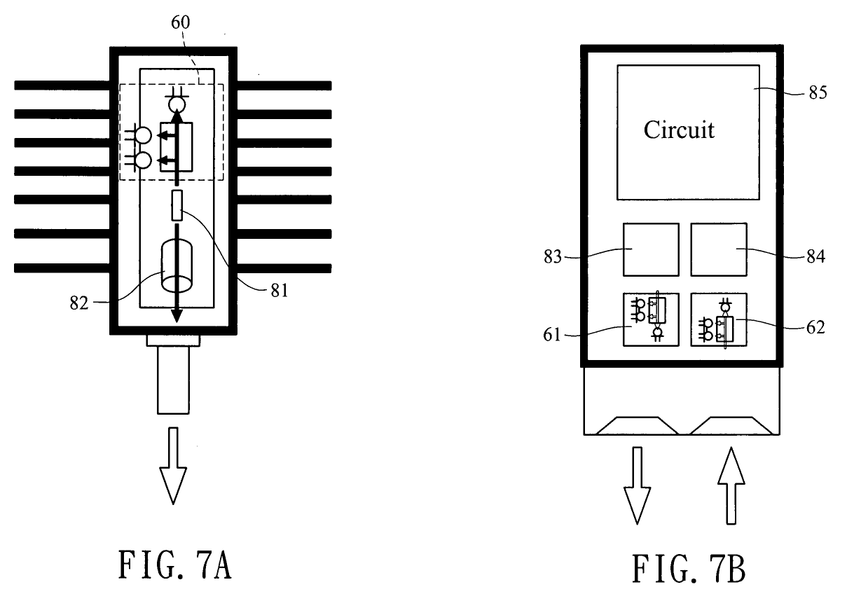

Please refer to FIG. 7A. The disclosed wavelength meter 60 is integrated in a laser-emitting module. Along with a laser 81 and a collimator 82, the system can monitor the wavelength of the emitted laser at all times. On the other hand, as shown in FIG. 7B, two sets of the disclosed wavelength meters 61, 62 are integrated with an emitting module 83, a receiving module 84, and a driver circuit 85 in an optical transceiving module. The driver circuit 85 controls the emitting module 83 to emit an optical signal and the receiving module 84 to receive an input optical signal. The wavelength meters 61, 62 are installed on the optical paths. That is, the optical signal emitted from the emitting module 83 first passes or is sampled by the wavelength meter 61. As the external optical signal enters the system, it also first passes or is sampled by the wavelength meter 62 before entering the receiving module 84. Therefore, the invention can be used to measure the wavelength of the transmitted optical signal.

Certain variations would be apparent to those skilled in the art, which variations are considered within the spirit and scope of the claimed invention.

1. A wavelength meter for measuring the wavelength of an incident beam of light, comprising:
a beam splitting device, which receives the incident beam and splits it into two beams of light;
two interferometers, which are wavelength-dependent and used to receive the two beams of light for sending out different powers, the two interferometers having different characteristic curves covering large wavelength ranges and small wavelength ranges, respectively; and
two photo sensors, which couple to the two interferometers and receive the beams of light;
wherein a rough range of the wavelength is determined by comparing the power received by the photo sensor associated with interferometer covering large wavelength ranges with its characteristic curve and the wavelength is determined by comparing the power received by the photo sensor associated with interferometer covering small wavelength ranges with its characteristic curve.

2. The wavelength meter of claim 1, wherein the characteristic curve of the interferometer covering small wavelength ranges has a higher sensitivity to the wavelength.

3. The wavelength meter of claim 2, wherein the characteristic curve is a periodic wave.

4. The wavelength meter of claim 2, wherein the interferometer covering small wavelength ranges is selected from the group consisting of a Fabry-Perot interferometer, an etalon/thin film filter, and a fiber Bragg grating (FBG).

5. The wavelength meter of claim 1, wherein the interferometer covering large wavelength ranges is selected from the group consisting of a Fabry-Perot interferometer, an etalon/thin film filter, and a fiber Bragg grating (FBG).

6. The wavelength meter of claim 5, wherein the characteristic curve of the interferometer covering large wavelength ranges is a symmetric wave.

7. The wavelength meter of claim 1, wherein the characteristic curves of the two interferometers are both periodic waves and satisfy:
FSR1=2*n*FSR2+Δ,
where FSR1 is the free spectral range (FSR) of the interferometer covering large wavelength ranges, FSR2 is the FSR of the interferometer covering small wavelength ranges, n is an integer, and Δ is a fine-tuning constant.

8. The wavelength meter of claim 1, wherein the characteristic curves of the two interferometers are both periodic waves and satisfy:
FSR1=2*(n+½)*FSR2+Δ,
where FSR1 is the free spectral range (FSR) of the interferometer covering large wavelength ranges, FSR2 is the FSR of the interferometer covering small wavelength ranges, n is an integer, and Δ is a fine-tuning constant.

9. The wavelength meter of claim 1, wherein the beam splitting device is selected from the group consisting of a beam splitter, a beam splitting crystal, a triangular crystal, a triangular pillar, a rectangular crystal, a parallelogram crystal, and a trapezoid crystal.
